(19) United States
(12) Patent Application Publication
(10) Pub. No.: US 2024/0240475 A1
(43) Pub. Date: Jul. 18, 2024

(54) BOOM-ARM SEGMENT FOR A CONCRETE PUMP

(71) Applicant: Putzmeister Engineering GmbH, Aichtal (DE)

(72) Inventors: Ansgar Müller, Aichtal (DE); Benjamin Rau, Aichtal (DE)

(21) Appl. No.: 18/556,750

(22) PCT Filed: Apr. 22, 2022
(86) PCT No.: PCT/EP2022/060664

§ 371 Date: Oct. 23, 2023

(30) Foreign Application Priority Data
Apr. 28, 2021 (EP) 21170838.3

(51) Int. Cl. E04G 21/04

(52) U.S. Cl. CPC E04G 21/0445; E04G 21/0436

(57) ABSTRACT

The invention relates to a boom-arm segment, comprising an upper chord (33), a lower chord (34) and two side parts (35, 36) connecting the upper chord (33) and the lower chord (34). The boom-arm segment (30) comprises a hinge connection (62) which defines a pivot axis (74) for a pivot connection between the boom-arm segment (21) and an adjacent structure (20), wherein: the pivot axis (74) is located below the plane (63) of the lower chord (34); a transition piece (64) is located between the lower chord (34) and the hinge connection (62), and the connection (65) between the transition piece (64) and the lower chord (34) is spaced apart from the adjacent end (61) of the lower chord (34); the transition piece (64) is enclosed between a first reinforcement part (40) and a second reinforcement part (70) which laterally adjoin the transition piece (64); the reinforcement parts (40, 70) each have a lower edge (69) which extends from the hinge connection (62) to the lower chord (34); and the lower edges (69) enclose an angle (68) with the plane (63) of the lower chord (34) that is smaller than the angle (67) which the transition piece (64) encloses with the plane (63) of the lower chord (34).

### BACKGROUND

The invention relates to a boom arm segment for a concrete pump.

With a concrete pump boom arm, a conveying line of a concrete pump can be guided in such a manner that the liquid concrete which is conveyed with the concrete pump is discharged in a region remote from the concrete pump. A concrete pump boom arm is generally composed of a plurality of boom arm segments, wherein in a folded-out state the boom arm segments overall amount to the length of the boom arm and wherein in a folded-in state the boom arm segments are folded together in a compact state in order to facilitate transport.

Boom arm segments are known, for example, from the documents CN 205 036 090 U and CN 110 984 578 B.

Concrete pumps normally convey the liquid concrete intermittently so that the boom arms are subjected to considerable dynamic loads. In addition, the boom arm segments, depending on the distance from the concrete pump at which the liquid concrete is intended to be discharged, can be folded differently when the concrete pump is operational. This leads to the tensile and pressure loads on a boom arm segment depending on the operating state of the boom arm acting in very different directions. Boom arm segments of a concrete pump are for these reasons subjected to specific loads during operation.

### SUMMARY

An object of the invention is to provide a concrete pump boom arm segment which has a low weight and is cost-effective to produce. Based on the prior art mentioned, the object is achieved with the features of the independent claims. Advantageous embodiments are set out in the dependent claims.

The boom arm segment according to the invention comprises an upper chord, a lower chord and two side portions which connect the upper chord and the lower chord. The boom arm segment comprises an articulated joint which defines a pivot axis for a pivot connection between the boom arm segment and an adjacent structure. The pivot axis is arranged below the plane of the lower chord. A transition piece extends between the lower chord and the articulated joint. A first connection is formed between the transition piece and the lower chord. The first connection is spaced apart from the end of the lower chord. This indication relates to the end of the lower chord which is adjacent to the transition piece, that is to say, the nearest end of the lower chord, and the transition piece is also spaced apart from the opposing end of the lower chord. The transition piece is enclosed between a first reinforcement portion and a second reinforcement portion which laterally adjoin the transition piece. The reinforcement portions each have a lower edge which extends from the articulated joint to the lower chord. The lower edges enclose an angle with the plane of the lower chord which is smaller than the angle which the transition piece encloses with the plane of the lower chord.

The invention has recognized that, with the transition piece between the lower chord and the articulated joint, a particularly advantageous possibility is afforded of introducing the forces acting in the region of the articulated joint into the boom arm segment. In order to avoid tension peaks at the transition between the transition piece and the lower chord, the transition is arranged with spacing from the end of the lower chord.

The indications “above” and “below” refer to the state of the boom arm segment as shown in the drawings. The direction indications assume that the lower chord is orientated horizontally. This does not mean any limitation with respect to the subsequent assembly position of the boom arm segment, in particular assembly positions which are rotated through 90° or 180° with respect to the state shown in the Figures are possible.

The lower chord may extend from an end adjacent to the articulated joint along a straight line in the direction of an opposing end of the boom arm segment (longitudinal direction). The end, which is adjacent to the articulated joint, of the boom arm segment may be the proximal end. The plane of the lower chord is defined by the longitudinal direction of the lower chord and the dimension parallel with the pivot axis of the articulated joint. If the lower chord does not extend over the entire length of the boom arm in a plane, the plane of the lower chord is defined by means of a portion of the lower chord adjacent to the articulated joint.

It is possible for the lower chord also to extend in the transverse direction in the plane of the lower chord. Embodiments are preferred in which the lower chord has in the transverse direction a shape which is guided out of the plane of the lower chord. To this end, the lower chord may have one or more bends or be provided with one or more folded portions. The direction of the edges/bends may be parallel with the longitudinal direction of the boom arm segment so that in the transverse direction a shape which is guided out of the plane is produced. The lower chord may have a shape which is curved in the transverse direction, for example, by the lower chord being folded in such a manner that the total of the folded portions corresponds to a curvature. The curvature may be orientated in such a manner that the spacing between the pivot axis of the articulated joint and a central region of the lower chord is smaller than the spacing between the pivot axis and a peripheral region of the lower chord. The plane of the lower chord is defined by the region of the lower chord which has the smallest spacing with respect to the articulated joint. Alternatively to a curved shape, edges which are bent in mutually opposing directions are also possible so that one or more beads are formed in the lower chord.

Particularly with a lower chord which is not planar in a transverse direction, it is advantageous for this longitudinal direction to be linear, that is to say, not to be guided out of the plane of the lower chord in the longitudinal direction. If there is no intersection between the plane of the lower chord and the articulated joint, a direct connection between the lower chord and the articulated joint which is arranged below the plane of the lower chord is not possible. With the invention, it is proposed that this connection be provided by means of a transition piece. Although—in comparison with constructions in which the articulated joint can be directly connected to the lower chord—during the production of the boom arm segment an additional component therefore has to be processed and additional operating steps are required, the solution has on the whole been found to be advantageous.

The boom arm segment is configured to be pivotably connected to an adjacent structure by means of a pivot joint. The adjacent structure may be a different segment of the boom arm or a base frame of the concrete pump. The pivot joint is formed by means of a first articulated joint, which is an element of the boom arm segment, and by a second articulated joint which is an element of the adjacent structure which is separate from the boom arm segment. The position of the pivot axis is defined by means of the articulated joint of the boom arm segment.

The articulated joint may comprise a joint bore, wherein the axis of the joint bore corresponds to the pivot axis. The articulated joint may comprise a structure inside which the joint bore is formed. For example, the articulated joint may be a pipe piece inside which the joint bore extends. The articulated joint may form a receiving member for an articulation bolt.

The transition piece extends from the first connection, via which the transition piece is connected to the lower chord, obliquely downward in the direction of the articulated joint. In this manner, the transition piece encloses an angle with the plane of the lower chord. The transition piece may enclose an angle between 5° and 50°, preferably between 10° and 40° with the plane of the lower chord. Angles outside this range are less advantageous for the force transmission between the lower chord and the articulated joint.

The transition piece may extend along a straight line between the lower chord and the articulated joint. Transversely relative thereto, the transition piece may also be linear so that the transition piece on the whole has a planar shape. Alternatively, the lower chord may have one or more bends or be provided with one or more folded portions. The direction of the edges/bends may be parallel with the longitudinal direction so that in the transverse direction a shape which is guided out of the plane is produced. The transition piece may have a shape which is curved in the transverse direction, for example, by the lower chord being folded in such a manner that the sum of the folded portions corresponds to a curvature. In the lateral dimension, the transition piece may extend over the entire width of the lower chord which the lower chord has in this portion.

A second connection may be formed between the transition piece and the articulated joint. The spacing between the second connection and the plane of the lower chord may be greater than the spacing between the pivot axis and the plane of the lower chord. Alternatively, the transition piece may also be arranged in such a manner that there is no direct connection between the transition piece and the articulated joint. The transition piece may in this instance comprise a portion which is arranged below the articulated joint. An adequate force transmission between the transition piece and the articulated joint may, for example, be ensured by both the transition piece and the articulated joint being arranged between two reinforcement portions so that the force transmission between the articulated joint and the transition piece is carried out by the reinforcement portions. In one embodiment, the transition piece adjoins a metal closure sheet which forms at the end of the boom arm segment a connection to the upper chord.

The transition piece may comprise sheet steel. The transition piece may be welded to the lower chord and/or to the articulated joint. The transition piece may be configured in such a manner that it terminates over the entire width thereof in a flush manner with the articulated joint and/or the lower chord. The weld connection to the articulated joint and/or the weld connection to the lower chord may extend over the entire width of the transition piece.

The spacing between the pivot axis of the articulated joint and the plane of the lower chord may be so large that the plane of the lower chord does not intersect with the joint bore of the articulated joint. In particular, the spacing between the pivot axis of the articulated joint and the plane of the lower chord may be so large that the plane of the lower chord does not intersect with the structure of the articulated joint.

The boom arm segment comprises a reinforcement portion which extends from the articulated joint to the lower chord. The reinforcement portion may extend beyond the lower chord into a side portion of the boom arm segment. The reinforcement portion may be configured to transfer forces acting on the articulated joint into the boom arm segment. The reinforcement portion comprises a lower edge which extends from the articulated joint to the lower chord. The lower edge encloses an angle with the plane of the lower chord which is smaller than the angle which the transition piece encloses with the plane of the lower chord. The difference of the angles may, for example, be between 2° and 20°, preferably between 5° and 10°.

With respect to a determined longitudinal position of the lower chord, the spacing between the lower edge of the reinforcement portion and the plane of the lower chord may be greater than the spacing between the transition piece and the plane of the lower chord. This may in particular apply to the region in which the transition piece is connected to the articulated joint. This may further apply over the entire length of the transition piece. The transition piece may be welded over the length thereof to the reinforcement portion. A configuration in which the transition piece is spaced apart from the lower edge of the reinforcement portion has the advantage that the forces transmitted from the articulated joint can be distributed in a more uniform manner.

The transition piece is enclosed between a first reinforcement portion and a second reinforcement portion which laterally adjoin the transition piece. The reinforcement portions may also enclose the articulated joint and/or a portion of the lower chord between them. Both reinforcement portions may have the features mentioned above.

The end of the lower chord may be enclosed between the reinforcement portions. The end of the lower chord may be spaced apart from an edge, which is located in an extension of the lower chord, of the reinforcement portion.

For the purposes of force distribution according to the invention, the connection between the transition piece and the lower chord has a spacing from the end of the lower chord, there is thus a portion of the transition piece which is arranged below the lower chord. The portion of the transition piece arranged below the lower chord may amount to at least 5%, preferably at least 10%, more preferably at least 30% of the length of the transition piece. This indication refers to the region of the lower chord in which the proximal end of the lower chord has the largest spacing with respect to the transition with the transition piece. This may be a lateral region of the lower chord at which the lower chord terminates in the reinforcement portions. A central region of the lower chord can in contrast be cut out and recessed. Preferably, the recessed region also has a spacing with respect to the connection between the transition piece and the lower chord.

The use of such a transition piece is particularly advantageous when the side portions of the boom arm segment are bent inward. It is then possible to connect the two reinforcement portions which enclose the transition piece between them to the side portions, as described below.

The side portion of the boom arm segment may have a folded portion so that a central portion of the side portion is laterally inwardly offset relative to an edge portion of the side portion. Between the edge portion and the central portion there may be a transition portion which forms a connection between the edge portion and the central portion. The reinforcement portion may have a material thickness which bridges the lateral offset between the edge portion and the central portion.

The reinforcement portion may be connected in abutment with the transition portion. In the regions of the edge portion and the central portion adjoining the transition portion, a direct connection may also be provided between the reinforcement portion and the side portion. The connection between the side portion and the reinforcement portion may be in the form of a weld connection. The weld connection may be constructed in abutment over the entire length of the connection between the reinforcement portion and the side portion so that an end face of the reinforcement portion is welded to an end face of the side portion. It is also possible for the weld connection to comprise portions which are butt-welded and overlap-welded. The butt-welded portions of the weld connection may comprise the connection to the transition portion of the side portion and other portions.

In one embodiment, the reinforcement portion is connected in abutment with the edge portion of the side portion and connected so as to overlap with the central portion of the side portion. The edge portion of the side portion may adjoin the upper portion or the lower chord of the boom arm segment. The reinforcement portion may be connected to the central portion of the side portion by means of a weld seam which extends along a portion of a circumferential edge of the reinforcement portion.

The side portion may be configured in such a manner that it comprises an upper edge portion which adjoins the upper chord and a lower edge portion which adjoins the lower chord. The reinforcement portion may be sized in such a manner that it is connected in abutment both to the transition portion between the central portion and the upper edge portion and to the transition portion between the central portion and the lower edge portion. In addition, the reinforcement portion may be connected in abutment both to the upper edge portion and to the lower edge portion. The reinforcement portion may have an overlapping connection to the central portion. An upper end of the reinforcement portion may terminate in the upper edge portion.

The reinforcement portion may comprise an end region which terminates inside the side portion. The end region may terminate in the form of a tapering in the side portion. The end region may overlap with the side portion. The tip of the end region may terminate in the central portion of the side portion. The term “tip” is used to refer to the outermost point of the end region, regardless of whether the end region tapers acutely at that location or has a different shape, for example, is rounded. The tip of the end region may be arranged close to the neutral fiber of the boom arm segment which means that the spacing between the tip of the end region and the nearest chord is at least twice, preferably three times, more preferably five times greater than the spacing between the tip and the neutral fiber.

The articulated joint may form a proximal joint receiving member of the boom arm segment. In the reinforcement portion, a receiving member for an articulation bolt may be formed. There may be connected to the reinforcement portion an articulated lever to which a hydraulic cylinder can be connected. The hydraulic cylinder has the function of pivoting the boom arm segment relative to an adjacent structure, in particular relative to an adjacent boom arm segment. The articulated lever may be connected to the reinforcement portion by means of a pivot connection.

The boom arm segment may comprise a securing receiving member for a retention member of a conveying line. The securing receiving member may extend in the transverse direction through the boom arm segment and form a transverse connection between the opposing side portions of the boom arm segment. For example, the securing receiving member may be welded to each of the side portions. The securing receiving member may extend between the central portions of the opposing side portions. The securing receiving member may in this manner provide additional protection from the side portions of the boom arm segment being deflected to the side under loading. As a result of the connection to the side portions, the forces applied by the secured elements can be readily introduced into the side portions.

At a side of the boom arm segment, the securing receiving member may protrude with respect to the side portion. At this side, the securing receiving member may be configured in such a manner that a retention member for the conveying line can be connected. For example, blind holes for a screw connection may be provided. However, it is also possible for the retention member to be welded, for example, to the securing receiving member. In one embodiment, the boom arm segment comprises a retention member which is connected to the securing receiving member for a conveying line and/or a conveying line which is connected to the securing receiving member. Furthermore, there may be connected to the boom arm segment hydraulic lines, via which, for example, hydraulic devices for folding in and folding out the boom arm can be operated.

The boom arm segment may comprise a plurality of such securing receiving members, in particular at least two securing receiving members, preferably at least three securing receiving members, more preferably at least four securing receiving members. The securing receiving members may be distributed in a substantially uniform manner over the length of the boom arm segment. One or more of the securing receiving members may be connected to a reinforcement portion.

The conveying line may extend over the length of the boom arm segment. For connection to a conveying line of an adjacent boom arm segment, the conveying line may comprise at one or both of the ends thereof an articulated portion which is configured to form a pivotable connection to a conveying line of an adjacent boom arm segment. The pivot axis defined with the articulated portion may be coaxial with respect to the pivot axis of the articulated joint and consequently coaxial with respect to the axis of the boom arm pivot joint. The conveying line may be arranged at the side of the boom arm segment. This is a significant peripheral condition for the construction of boom arm segments since, on the one hand, the possibility has to be afforded of moving the boom arm segments of a boom arm into a folded-in state in spite of the conveying line which is arranged in parallel and since, on the other hand, there is not a freely available amount of space in a lateral direction without the permissible width of road-legal vehicles being exceeded.

The invention further relates to a concrete pump boom arm having a plurality of boom arm segments, wherein at least one of the boom arm segments is constructed according to the invention. A pivot joint is formed between two adjacent boom arm segments in each case. The axis of the pivot joint may be orientated in such a manner that it extends through both side portions of the boom arm segment, wherein the two side portions are preferably cut at right-angles or enclose with this direction an angle less than 10°, preferably less than 5°. The chord faces may extend parallel with the pivot axis.

The joint may comprise a first articulated lever which is pivotably fastened to a first boom arm segment. The joint may comprise a second articulated lever which is pivotably fastened to the second boom arm segment and which is further pivotably fastened to the first articulated lever. A hydraulic cylinder may extend from the first boom arm segment up to the first articulated lever so that a lifting movement of the hydraulic cylinder is converted into a pivot movement between the boom arm segments. When viewed from the first boom arm segment, the hydraulic cylinder is preferably fastened to the first articulated lever at the other side of the second articulated lever.

The concrete pump boom arm may comprise a conveying line for a thick material, in particular fresh concrete, which extends along the boom arm. A segment of the conveying line may be associated with each segment of the boom arm. Adjacent segments of the conveying line may be connected to each other by means of a joint, wherein the joint axis is preferably coaxial with respect to the joint by means of which the associated boom arm segments are connected to each other. The individual segment of the conveying line may be in the form of a rigid pipeline.

### BRIEF DESCRIPTION OF THE DRAWINGS

The invention will be described by way of example below with reference to the appended drawings and advantageous embodiments. In the drawings:

FIG. 1: shows a concrete pump vehicle having a boom arm in the folded-in state;

FIG. 2: shows the concrete pump vehicle from FIG. 1 with the boom arm folded out;

FIG. 3: shows a boom arm segment according to the invention;

FIG. 4: shows a joint between two boom arm segments;

FIG. 5: shows the proximal end of the boom arm segment from FIG. 3 as an enlarged illustration;

FIG. 6: shows a cut-out from the boom arm segment from FIG. 3 as an enlarged illustration;

FIG. 7: shows the distal end of the boom arm segment from FIG. 3 as an enlarged illustration;

FIG. 8: shows a securing receiving member of the boom arm segment from FIG. 3 as an enlarged illustration;

FIG. 9: shows the securing receiving member from FIG. 8 in another perspective;

FIG. 10: shows the proximal end of the boom arm segment from FIG. 5 as a perspective illustration;

FIG. 11: shows the distal end of the boom arm segment from FIG. 7 as a perspective illustration;

FIG. 12: shows a cross section along line A-A in FIG. 5;

FIG. 13: shows a view obliquely from below of the proximal end of the boom arm segment from FIG. 5;

FIG. 14: shows the boom arm end from FIG. 13 without a lateral reinforcement portion;

FIG. 15: shows the boom arm end from FIG. 13 in a view from below;

FIG. 16: shows the boom arm end from FIG. 14 in a view obliquely from below.

### DETAILED DESCRIPTION

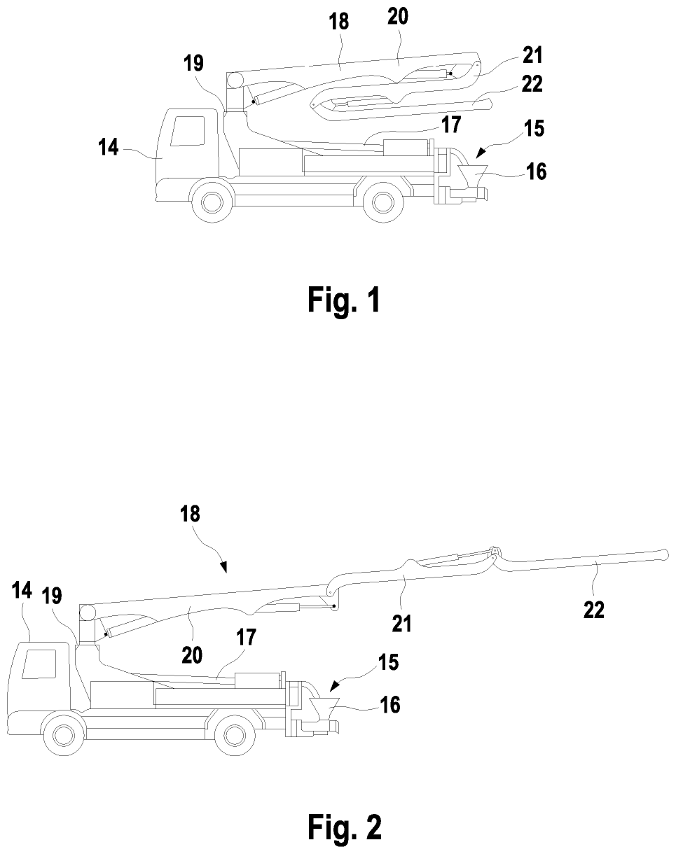

A truck 14 shown in FIG. 1 is provided with a concrete pump 15 which conveys liquid concrete from a prefilling container 16 through a conveying line 17. The conveying line 17 extends along a boom arm 18 which is rotatably supported on a rotary rim 19. The boom arm 18 comprises three boom arm segments 20, 21, 22 which are connected to each other in an articulated manner. By the boom arm segments 20, 21, 22 being pivoted relative to each other by means of the joints, the boom arm 18 can change between a folded-in state (FIG. 1) and a folded-out state (FIG. 2). The conveying line 17 extends beyond the distal end of the third boom arm segment 22 so that the liquid concrete can be discharged in a region remote from the concrete pump 15.

Depending on the pivot state of the boom arm, the loads act on the boom arm segments 20, 21, 22 in very different directions. In addition, the boom arm is subjected as a result of the intermittent conveying of the liquid concrete to a high dynamic loading.

The pivot joints between the boom arm segments 20, 21, 22 are configured in such a manner that they enable a large pivot angle. In the folded-in state, the boom arm segments 20, 21, 22 are located substantially parallel with each other and together enclose a small angle. In the folded-out state according to FIG. 2, the boom arm segments 20, 21, 22 extend substantially in extension of each other.

The joint construction is shown in FIG. 4 using the example of the pivot joint between the first boom arm segment 20 and the second boom arm segment 21. The pivot axis 74 is formed by means of an articulation bolt 23 by means of which a proximal end of the boom arm segment 21 is connected to a distal end of the boom arm segment 20. Adjacent to the articulation bolt 23 on the first boom arm segment 20 a first articulated lever 24 is fastened. On the second boom arm segment 21 adjacent to the articulation bolt 23, a second articulated lever 25 is fastened. The two articulated levers are connected to each other in an articulated manner at 26. A hydraulic cylinder 27 extends from a receiving member 28 on the first boom arm segment 20 up to the outer end of the first articulated lever 24. Via the articulated levers 24, 25, a lifting movement of the hydraulic cylinder 27 is converted into a pivot movement between the boom arm segments 20, 21.

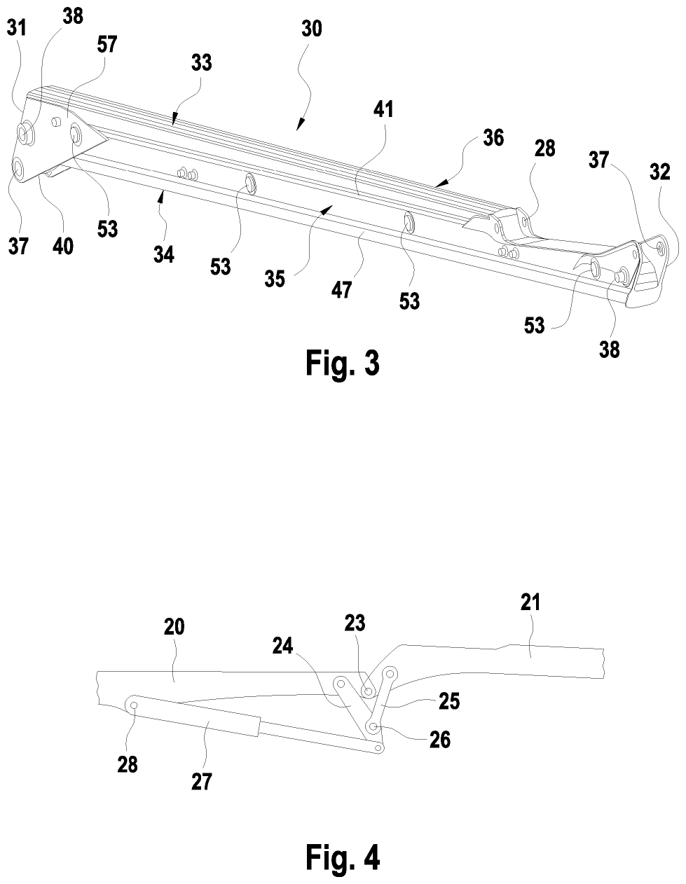

A boom arm segment 30 according to the invention shown in FIG. 3 extends from a proximal end 31 up to a distal end 32. The boom arm segment 30 is in the form of a box-like profile having an upper chord 33, a lower chord 34 and two side portions 35, 36. The box-like profile of the boom arm segment tapers continuously from the proximal end 31 up to the receiving member 28 for the hydraulic cylinder. The two side portions 35, 36 and the upper chord 33 and the lower chord 34 thus move closer to each other with increasing spacing from the proximal end 31.

Close to the proximal end 31, the boom arm segment 30 is reinforced with a first reinforcement portion 40 which forms a proximal joint receiving member 57 of the boom arm segment 30. From the first reinforcement portion 40, the box-like profile extends in the direction of the distal end 32. The box-like profile is composed of an upper half-shell 41 and a lower half-shell 47 which are each in the form of bent metal sheets.

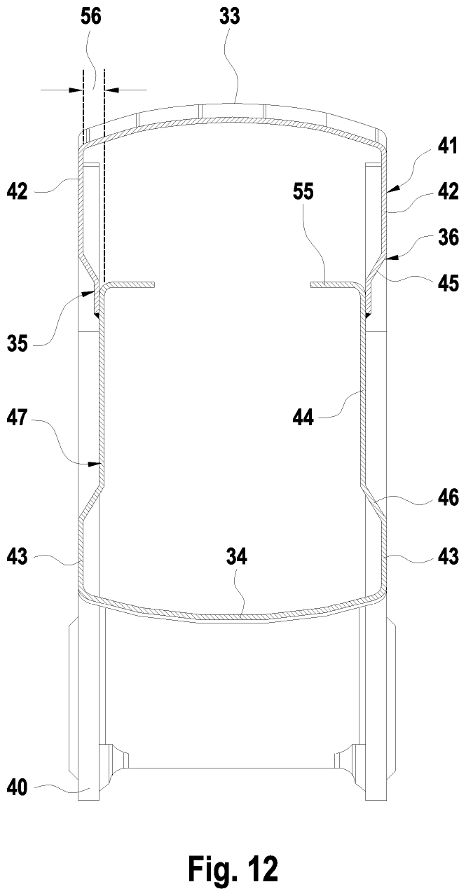

According to the cross sectional illustration in FIG. 12, the two side portions 35, 36 each comprise an upper edge portion 42 which adjoins the upper chord 33 and a lower edge portion 43 which adjoins the lower chord 34. The upper edge portions 42 and the lower edge options 43 are located in the same plane. Between the edge portions 42, 43, there is arranged a central portion 44 which has a lateral offset 56 relative to the edge portions 42, 43. The side portions 35, 36 are folded inward so that the central portions 44 of the two side portions 35, 36 have a smaller spacing with respect to each other than the edge portions 42, 43 of the side portions 35, 36. There are formed between the central portion 44 and the edge portions 42, 43 transition portions 45, 46 which each enclose an angle of approximately 30° with the plane of the edge portions 42, 43 or the parallel plane of the central portions 44.

The upper half-shell 41 comprises the upper chord, the upper edge portions 42, the upper transition portions 45 and the upper portion of the central portions 44 in each case of both side portions 35, 36. The lower half-shell 47 comprises the lower chord 34, the lower edge portions 43, the lower transition portions 46 and the lower portion of the central portions 44 of both side portions 35, 36 in each case. The upper end of the lower half-shell 47 overlaps with the lower end of the upper half-shell 41. At the lower end of the upper half-shell 47, there is formed a weld seam by means of which the two half-shells 41, 47 are connected to each other. The lower half-shell 47 is folded inward with the end edge 55 thereof and consequently forms a buckling reinforcement for the box-like profile.

The first reinforcement portion 40 has a greater material strength than the box-like profile comprising the half-shells 41, 47, see FIG. 12. The outer side of the first reinforcement portion 40 coincides with the outer side of the upper edge portions 42. The inner side of the first reinforcement portion 40 coincides with the outer side of the central portions 44. With the transition portions 45, 46, the box-like profile changes between the outer side and the inner side of the first reinforcement portion 40.

The transition portions 45, 46 and the edge portions 42, 43 are welded in abutment with the first reinforcement portion 40. The central portions 44 overlap with the first reinforcement portion 40. The connection between the first reinforcement portion 40 and the central portions 44 is formed by a circumferential weld seam around the first reinforcement portion 40.

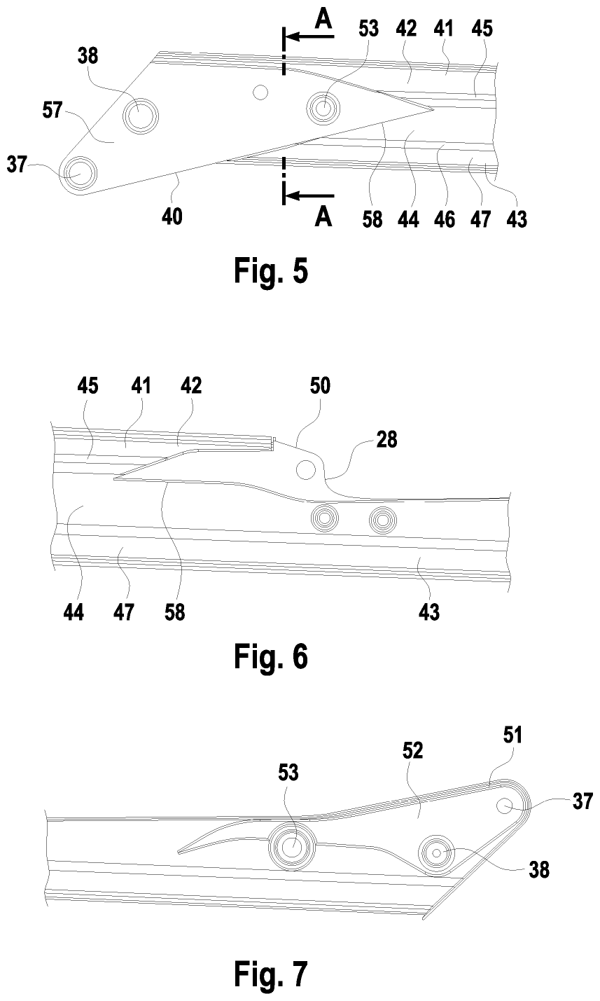

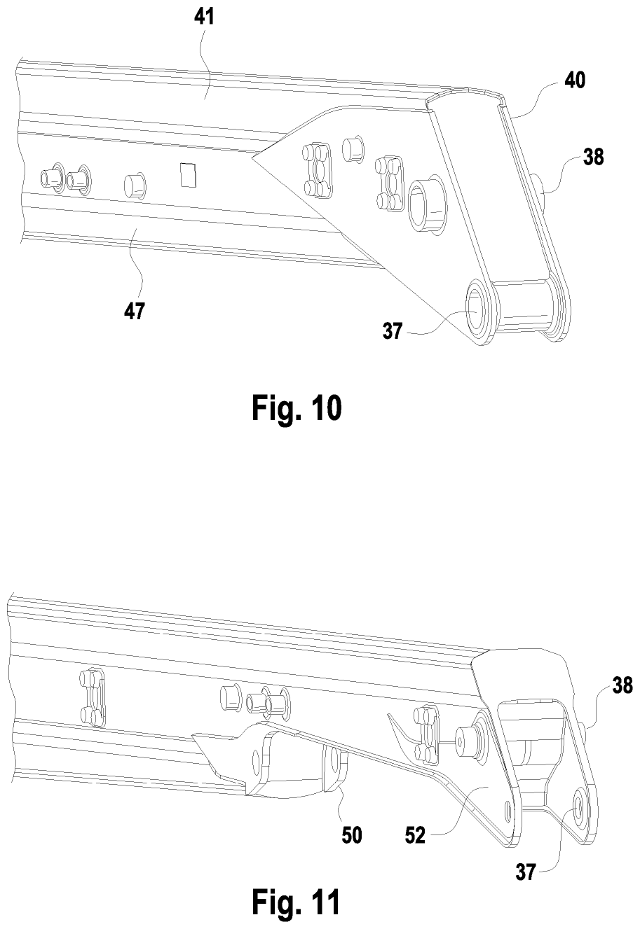

According to FIGS. 5, 10, a joint bore 37 is formed in the first reinforcement portion 40. The joint bore receives the articulation bolt 23 which connects the boom arm segment 30 to an adjacent boom arm segment. Beside the joint bore 37, the articulated lever 25 can be connected. Accordingly, the mast arm segment 30 comprises close to the distal end thereof another joint bore 37 and another stay bolt 38 to which an articulated lever 24 can be connected.

The boom arm segment 30 comprises an additional reinforcement portion 50 which forms the receiving member 28 for the hydraulic cylinder. The additional reinforcement portion 50 has the same material thickness as the first reinforcement portion 40 and merges in the same manner into the contour of the upper half-shell 41. The additional reinforcement portion 50 thus overlaps with the central portions 44 of the side portions 35, 36 and is connected at that location by means of a circumferential weld seam to the upper half-shell 41. The upper transition portion 45 and the upper edge portion 42 are butt-welded to the additional reinforcement portion 50.

The distal joint receiving member 51 shown in FIGS. 7 and 11 comprises a metal reinforcement sheet 52 which is doubled onto the metal sheet of the box-like profile. The connection between the metal reinforcement sheet 52 and the box-like profile is formed by means of a circumferential weld seam which extends over the circumference of the metal reinforcement sheet 52. The joint receiving member 51 comprises a joint bore 37 which receives the articulation bolt 23 for the connection to an adjacent boom arm segment. Beside the joint bore 37 there is arranged a stay bolt 38 to which the articulated lever 25 is connected.

The boom arm segment comprises according to FIG. 3 a plurality of securing receiving members 53 for fitting to retention members (not illustrated) for the conveying line 17. A first securing receiving member 53 is connected to the first reinforcement portion 40. Two additional securing receiving members 53 are arranged in the side portions 35, 36 of the box-like profile. A fourth securing receiving member 53 is arranged close to the distal joint receiving member 51.

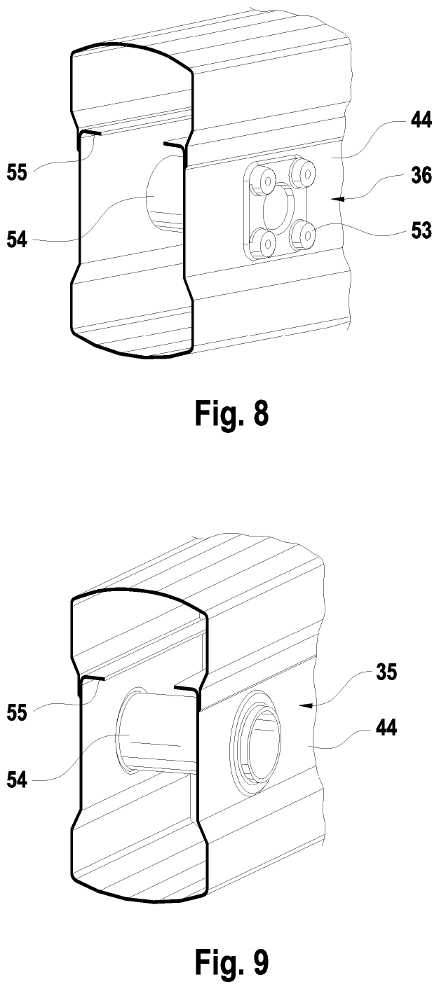

According to FIGS. 8 and 9, the securing receiving member 53 forms a transverse connection 54 between the first side portion 35 and the second side portion 36. The transverse connection 54 is formed by means of a pipe piece which is welded to the central portions 44 of both side portions 35, 36. By the side portions 35, 36 being retained by the pipe piece 54 at a fixed spacing with respect to each other, the securing receiving members 53 counteract a buckling deformation of the boom arm segment 30.

At the side of the first side portion 35, the pipe piece 54 terminates as a pipe end which protrudes slightly with respect to the central portion 44 of the side portion 35. At the side of the second side portion 36, the securing receiving member 53 is provided with four threaded holes to which the retention member for the conveying line can be securely screwed.

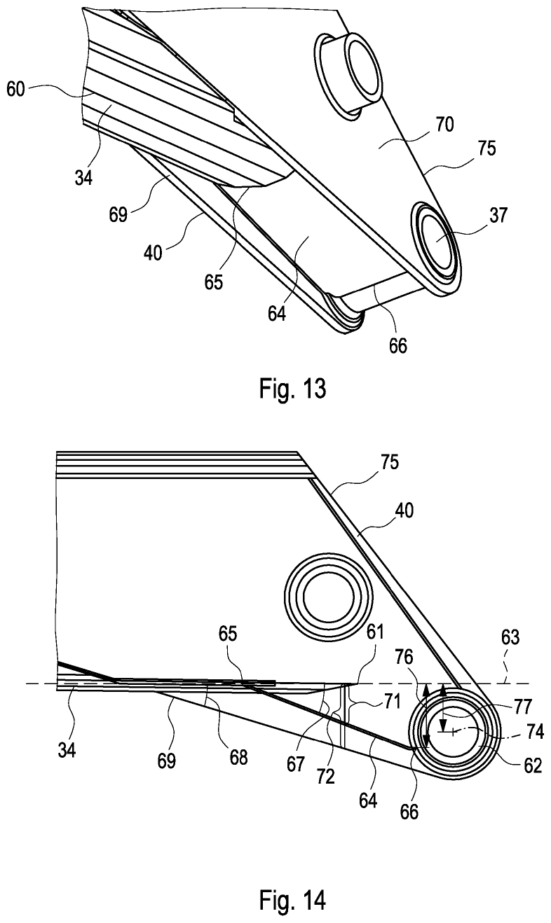

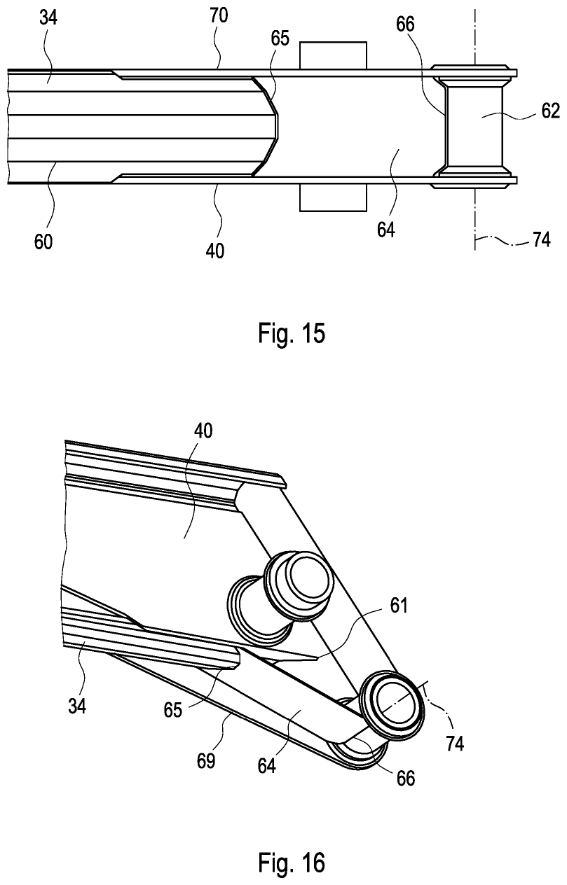

According to FIG. 13, the lower chord 34 is formed by means of a metal sheet which is planar in the longitudinal direction and which has in a transverse direction as a result of four bent portions 60 an outwardly curved shape. The proximal end 61 of the lower chord is formed by means of two tips which terminate laterally with a rounded recess located therebetween. The side edges of the lower chord 34 are welded as far as the tips to the reinforcement portions 40, 70. The proximal end 61 of the lower chord is located in the center of the reinforcement portions 40, 70 and is consequently spaced apart from the edge 75 of the reinforcement portions 40, 70 which is located in the extension of the lower chord 34.

The joint bore 37 extends inside a pipe piece which forms the articulated joint 62. The pipe piece is arranged with the entire cross section thereof below the plane 63 of the lower chord 34 so that no direct connection is possible between the lower chord 34 and the articulated joint 62.

Between the articulated joint 62 and the lower chord 34 there extends a transition piece 64 which is in a connection 65 with respect to the lower chord 34 and in a connection 66 with respect to the articulated joint 62. The connection 66 to the articulated joint 62 has a greater spacing with respect to the plane 63 of the lower chord than the pivot axis 74. The transition piece 64 encloses an angle 67 of approximately 20° with the plane 63 of the lower chord. This angle 67 is slightly larger than the angle 68 which the lower edge 69 of the reinforcement portion 40 encloses with the plane 63 of the lower chord. With respect to a specific longitudinal position in the plane 63 of the lower chord 34, the spacing 72 between the lower edge 69 of the reinforcement portion 40 and the plane 63 is greater than the spacing 71 between the transition piece 64 and the plane 63. The spacing 76 between the connection 66 to the articulated joint 62 and the plane 63 is greater than the spacing 77 between the pivot axis 74 and the plane 63.

1. A boom arm segment for a concrete pump, having an upper chord (33), a lower chord (34) and two side portions (35, 36) which connect the upper chord (33) and the lower chord (34), wherein the boom arm segment (30) comprises an articulated joint (62) which defines a pivot axis (74) for a pivot connection between the boom arm segment (21) and an adjacent structure (20), wherein the pivot axis (74) is arranged below a plane (63) of the lower chord (34), wherein a transition piece (64) is arranged between the lower chord (34) and the articulated joint (62), wherein a first connection (65) is formed between the transition piece (64) and the lower chord (34), wherein the first connection (65) is spaced apart from the end (61) of the lower chord (34) adjacent the pivot axis (74), wherein the transition piece (64) is enclosed between a first reinforcement portion (40) and a second reinforcement portion (70) which laterally adjoin the transition piece (64), wherein the reinforcement portions (40, 70) each have a lower edge (69) which extends from the articulated joint (62) to the lower chord (34) and wherein the lower edges (69) enclose an angle (68) with the plane (63) of the lower chord (34) which is smaller than an angle (67) which the transition piece (64) encloses with the plane (63) of the lower chord (34).

2. The boom arm segment of claim 1, wherein the lower chord (34) is provided with folded portions (60).

3. The boom arm segment of claim 2, wherein the lower chord (34) is curved in a transverse direction.

4. The boom arm segment of claim 1, wherein the transition piece (64) encloses an angle of between 5° and 50° with the plane (63) of the lower chord (34).

5. The boom arm segment of claim 1, wherein the transition piece (64) extends over the entire width of the lower chord (34).

6. The boom arm segment of claim 1, wherein the transition piece (64) is welded to the lower chord (34) or to the articulated joint (62).

7. The boom arm segment of claim 1, wherein a second connection (66) is formed between the transition piece (64) and the articulated joint (62) and in that the second connection (66) has a spacing (76) with respect to the plane (63) of the lower chord (34) which is larger than a spacing (77) between the pivot axis (74) and the plane (63) of the lower chord (34).

8. The boom arm segment of claim 1, wherein with respect to a given longitudinal position along the lower chord (34), a spacing (72) between the lower edge (69) of the reinforcement portion (40, 70) and the plane (63) of the lower chord (34) is greater than a spacing (71) between the transition piece (64) and the plane (63) of the lower chord (34).

9. The boom arm segment of claim 1, wherein the end (61) of the lower chord (34) is enclosed between the reinforcement portions (40, 70) and in that the end (61) of the lower chord (34) is spaced apart from an edge (75), which is located in extension of the lower chord (34), of the reinforcement portion (40, 70).

10. The boom arm segment of claim 1, wherein the transition piece (64) encloses an angle of between 10° and 40° with the plane (63) of the lower chord (34).

11. The boom arm segment of claim 1, wherein the transition piece (64) is welded to the lower chord (34) and to the articulated joint (62).
